(19) United States
(12) Patent Application Publication
(10) Pub. No.: US 2015/0325987 A1
(43) Pub. Date: Nov. 12, 2015

(54) Submarine Cable System

(71) Applicant: GWAVE LLC, Hanover, NH (US)

(72) Inventor: Glenn L. Beane, Hanover, NH (US)

(21) Appl. No.: 14/709,517

(22) Filed: May 12, 2015

Related U.S. Application Data
(60) Provisional application No. 61/991,963, filed on May 12, 2014.

(51) Int. Cl. H02G 1/10; B63B 22/04

(52) U.S. Cl. CPC H02G 1/10; B63B 22/04; B63B 2207/02

(57) ABSTRACT

A system and method of utilizing a submarine cable system. The cable system comprises a plurality of buoys tethered to anchors. The tethers are adjustable in length to allow for suspending a submersible cable above the seafloor when installed. The system allows for cost savings, by minimizing the length of submersible cable needed to traverse a body of water.

### CROSS-REFERENCE TO RELATED APPLICATIONS

The present application claims the benefit of Provisional Patent Application Ser. No. 61/991,963 filed May 12, 2014, which is incorporated herein by reference.

### FIELD OF THE INVENTION

The present invention relates to submarine cables and more particularly to a system and method of suspending submarine cables with anchored buoys.

### BACKGROUND OF THE INVENTION

It is recognized that communication, electrical, and other cables must necessarily cross bodies of water. In such cases, the cable is generally submerged to avoid any collisions with vessels and the like and to remove obstructions from the surface of a body of water. For simplicity the submarine cables that will be discussed herein will be referred to in the context of cables found in the ocean, or the sea, but it is understood by those of skill in the art that the cable system described herein is equally suited for fresh water applications.

Underwater, or submarine, cables are typically installed with large cable laying vessels that drop a line of cable along the bottom of a body of water, which by necessity requires additional lengths of cable for areas of increased depths and/or to accommodate various topologies along the seafloor. In some cases, underwater, or submarine, cables are installed by using cable burial plows, or the like, to place the cable a certain distance under the seafloor especially in more shallow areas. See, for example, U.S. Pat. No. 2,067,717 and U.K. Pat. No. GB 0524831. Depending on the region or the particular body of water, there may be benefits or drawbacks to burying the cable. Regardless, the amount of cable required to trace the topology of the seafloor in current systems is necessarily larger, and as such more costly, than would be required for the system of the present invention.

### SUMMARY OF THE INVENTION

One aspect of the present invention is a submarine cable system for suspending a submersible cable above a seafloor comprising a submersible cable having a length, a first end, and a second end; a plurality of buoys configured to attach to the submersible cable; a plurality of tethers, each having a length, a first end and a second end, wherein the first end of each tether is in contact with a buoy; and a plurality of anchors, wherein each anchor is in contact with the second end of a tether thereby suspending the submersible cable above the seafloor when the submersible cable is submerged.

One embodiment of the submarine cable system is wherein the plurality of buoys is spaced along the length of the submersible cable.

One embodiment of the submarine cable system is wherein each of the plurality of tethers is adjustable in length.

One embodiment of the submarine cable system is wherein adjusting the length of each tether is done remotely.

One embodiment of the submarine cable system is wherein the first end of the submersible cable is attached to a vessel.

One embodiment of the submarine cable system is wherein the first end of the submersible cable is attached to a generator.

One embodiment of the submarine cable system is wherein the first end of the submersible cable is attached to land.

Another aspect of the present invention is a buoy system for suspending a submersible cable above a seafloor comprising a buoy configured to attach to a submersible cable; a tether, having a length, a first end and a second end, wherein the first end of the tether is connected to the buoy; and an anchor, wherein the anchor is connected to the second end of the tether.

One embodiment of the buoy system for suspending a submersible cable above a seafloor wherein the length of the tether is adjustable.

One embodiment of the buoy system for suspending a submersible cable above a seafloor wherein adjusting the length of the tether is done remotely.

Another aspect of the present invention is a method for suspending a submersible cable above a seafloor comprising providing a submersible cable having a length, a first end, and a second end; providing a plurality of buoys configured to attach to the submersible cable; providing a plurality of tethers, wherein each tether has a length, a first end and a second end, and wherein the first end of each tether is in contact with one of the plurality of buoys; providing a plurality of anchors, wherein each anchor is in contact with the second end of one of the plurality of tethers; and adjusting the length of each of the plurality of tethers to suspend the submersible cable above the surface of the seafloor when the cable is submerged.

One embodiment of the method for suspending a submersible cable above a seafloor is wherein adjusting the length of a tether is done remotely.

One embodiment of the method for suspending a submersible cable above a seafloor is wherein the first end of the submersible cable is attached to a vessel.

One embodiment of the method for suspending a submersible cable above a seafloor is wherein the first end of the submersible cable is attached to a generator.

One embodiment of the method for suspending a submersible cable above a seafloor is wherein the second end of the submersible cable is attached to land.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows one embodiment of the submarine cable system of the present invention.

### DETAILED DESCRIPTION OF THE INVENTION

It is recognized that communication, electrical, and other cables must necessarily cross bodies of water. These cables are submerged and are typically draped along the seafloor or are buried in sections of the seafloor. In some cases, the cable contains a series of buoys, which are used to aid in the installation of the cable. See, for example, U.S. Pat. No. 4,659,253, where evenly spaced buoys are fixed along the cable such that they do not move during installation so that the cable tension can be controlled during installation and so that the cable does not result in a runaway situation. Runaway situations can be very dangerous and costly. Upon installation of the cable, these buoys are suspended above the cable that has been installed along the seafloor. Similarly, in other systems, such as is described in U.S. Pat. No. 4,048,686, buoys are used during the installation of the cable to reduce tension on the cable system beyond its maximum tolerances. The weight of cables varies considerably depending on whether the cable is a power cable, a communication cable, or some other type of cable. In U.S. Pat. No. 4,048,686, the buoys detach at a particular depth to release the cable to its final resting position along the seafloor.

In contrast, the submarine cable system of the present invention retains the buoys on the submersible cable and the buoys do not extend above the submersible cable when it is installed on the seafloor. Rather, the buoys are used to elevate the submersible cable from the seafloor. In certain embodiments, the buoys are tethered to anchors. The system of the present invention provides for reduced cable cost by minimizing the length of submersible cable required to traverse a body of water by using anchored buoys with tethers of varying lengths to accommodate a variety of seafloor topologies. Additionally, when the submersible cable needs to be repaired, without some form of buoying system such as described herein, the weight of the submersible cable would be prohibitively heavy and would make repairs difficult. The system of the present invention provides for a mechanism for a repair vessel to more easily grab the submersible cable and to hoist it into to position for repairs.

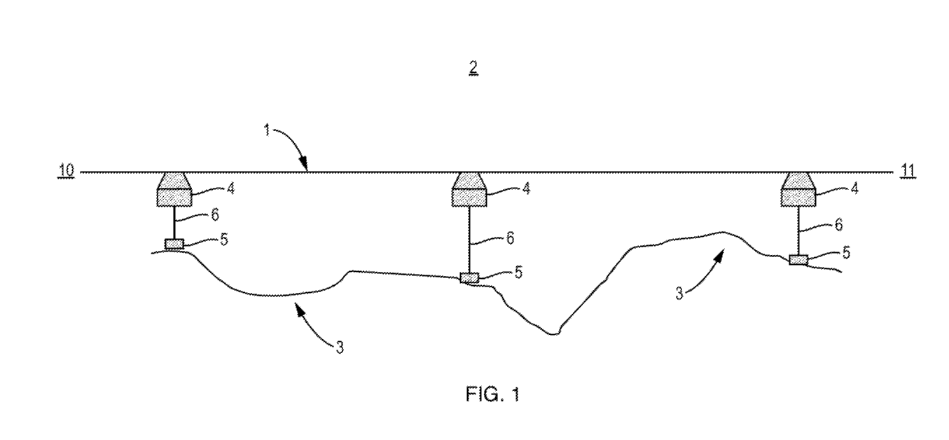

Referring to FIG. 1, one embodiment of the submarine cable system of the present invention is shown. More particularly, a submersible cable 1 shown in the ocean 2 suspended some distance off the seafloor 3. In certain embodiments of the present invention, a plurality of buoys 4 is used to suspend the submersible cable some distance off the seafloor to minimize the length of submersible cable needed to traverse a body of water. In certain embodiments of the present invention, the plurality of buoys 4 is anchored to the seafloor by a plurality of anchors 5. The plurality of anchors 5 is tethered to the plurality of buoys 4 via tethers 6 of various lengths so that the submersible cable may be suspended in a nearly horizontal fashion regardless of the topology of the seafloor. In certain embodiments of the system of the present invention, the lengths of the tethers 6 are adjustable to facilitate installation in various underwater environments (e.g., a variety of depths, contours, and the like.). In certain embodiments, the length of the tethers 6 is configured to be adjusted remotely.

In certain embodiments of the present invention, the submersible cable 1 has a first end 10 and second end 11. In certain embodiments, the first end 10 of the cable 1 is attached to an electrical generator. In certain embodiments, the electrical generator (not shown) can be a windmill, a flywheel, a power generator using solar, gas, diesel, wind, water or the like, or other forms of electrical or power generators known to those of skill in the art.

In certain embodiments of the present invention, the first end 10 of the cable 1 is attached to a vessel. In certain embodiments of the present invention, the first end of the cable is attached to a generator present on a vessel or platform configured to generate electrical energy. In certain embodiments of the present invention, the first end 10 of the cable 1 is attached to land. In certain embodiments, the connection to land comprises a connection to an electrical or power grid, an electrical or power storage facility or device, an electrical or power generator, or the like.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed:

1. An submarine cable system for suspending a submersible cable above a seafloor comprising:
a submersible cable having a length, a first end and a second end;
a plurality of buoys configured to attach to the submersible cable;
a plurality of tethers, each having a length, a first end and a second end and wherein the first end of each tether is in contact with a buoy; and
a plurality of anchors, wherein each anchor is in contact with the second end of a tether thereby suspending the submersible cable above the surface of the seafloor when the cable is submerged.

2. The submarine cable system of claim 1, wherein the plurality of buoys are spaced along the length of the submersible cable.

3. The submarine cable system of claim 1, wherein each of the plurality of tethers are adjustable in length.

4. The submarine cable system of claim 1, wherein adjusting the length of each tether is done remotely.

5. The submarine cable system of claim 1, wherein the first end of the submersible cable is attached to a vessel.

6. The submarine cable system of claim 1, wherein the first end of the submersible cable is attached to a generator.

7. The submarine cable system of claim 1, wherein the first end of the submersible cable is attached to land.

8. A buoy system for suspending a submersible cable above a seafloor comprising,
a buoy configured to attach to a submersible cable;
a tether, having a length, a first end and a second end and wherein the first end of the tether is connected to the buoy; and
an anchor, wherein the anchor is connected to the second end of the tether.

9. The buoy system for suspending a submersible cable of claim 8, wherein the length of the tether is adjustable.

10. The buoy system for suspending a submersible cable of claim 8, wherein adjusting the length of the tether is done remotely.

11. A method for suspending a submersible cable above a seafloor comprising
providing a submersible cable having a length, a first end and a second end;
providing a plurality of buoys configured to attach to the submersible cable;
providing a plurality of tethers, wherein each tether has a length, a first end and a second end, and wherein the first end of each tether is in contact with one of the plurality of buoys;
providing a plurality of anchors, wherein each anchor is in contact with the second end of one of the plurality of tethers; and
adjusting the length of each of the plurality of tethers to suspend the submersible cable above the surface of the seafloor when the cable is submerged.

12. The method of suspending a submersible cable of claim 11, wherein adjusting the length of a tether is done remotely.

13. The method of suspending a submersible cable of claim 11, wherein the first end of the submersible cable is attached to a vessel.

14. The method of suspending a submersible cable of claim 11, wherein the first end of the submersible cable is attached to a generator.

15. The method of suspending a submersible cable of claim 11, wherein the first end of the submersible cable is attached to land.
